(19) United States
(12) Patent Application Publication
(10) Pub. No.: US 2003/0126730 A1
(43) Pub. Date: Jul. 10, 2003

(54) Tubular assembly having hydroformed interconnecting member and method for making same

(76) Inventors: Mark W. Barber, Ontario (CA); John Dicesare, Ontario (CA)

Correspondence Address: PILLSBURY WINTHROP, LLP, P.O. BOX 10500, MCLEAN, VA, 22102, US

(21) Appl. No.: 10/203,902

(22) PCT Filed: Feb. 13, 2001
(86) PCT No.: PCT/CA01/00212

(51) Int. Cl. B23P 11/00

(52) U.S. Cl. 29/428

(57) ABSTRACT

A method for forming a hollow part (18) that allows the use of hydroforming in cases where the part interconnects between sections having extreme variations in cross-section. A complete hollow part (18) is formed by joining a hydroformed hollow section with hollow sections. A method for securing a fastener sleeve (102) insert in a pre-fabricated hollow part (100) is also provided. In this method, the hollow part (100) is deformed slightly to form flanges (108) that secure the insert (102) in the part. Once the insert (102) is secure in the hollow part, fasteners can be applied to the part without collapsing it.

### FIELD OF THE INVENTION

This invention relates generally to the field of motor vehicle frames, and more specifically to the hydroforming of hollow parts for use in motor vehicle frames.

### BACKGROUND OF THE INVENTION

Hollow parts for auto body construction, such as frame members or reinforcement beams, may ideally require a varying cross-sectional shape and/or perimeter along their length. Conventional hollow parts having varying cross-section may, for example, be stamped from two pieces of sheet metal, each piece forming two longitudinal halves of the completed tube. The two pieces are then welded together with two welded seams, each weld running the length of the part. This requires a relatively large amount of labor and welding to produce the finished hollow member, thus resulting in large processing expense.

One method for producing hollow parts with varying cross section is hydroforming. The process of hydroforming metal structural components is well known. See, for example, U.S. Pat. Nos. 4,567,743, 5,070,717, 5,107,693, 5,233,854, 5,239,852, 5,333,775, and 5,339,667, the disclosures of which are hereby incorporated by reference. In a conventional hydroforming process, a tubular metal blank member is placed into a die cavity of a hydroforming die. Opposite ends of the tube are sealed, and fluid is injected under pressure internally to the tubular blank so as to expand the blank outwardly into conformance with the interior surfaces defining the die cavity. In more recent improvements to the conventional hydroforming process, opposite ends of the tubular blank are forced longitudinally toward one another during outward expansion of the tube so as to replenish the wall thickness of the metal as it is expanded outwardly. An exemplary process for replenishing material by longitudinally compressing the blank is disclosed in U.S. Pat. Nos. 5,718,048, 5,855,394, 5,899,498, and commonly-assigned 5,979,201 and 6,014,879.

An advantage to hydroforming hollow parts is that high-strength parts having irregular cross-sectional configurations can be made easily and cost-effectively, in a manner which would be extremely difficult if not impossible to accomplish using stamping or roll-forming techniques.

For some applications where a hollow part requires extreme variations in cross-section, hydroforming becomes somewhat problematic in conventional hydroforming, the cross-section diameter of the uniform cross-sectioned blank (typically cylindrical in shape) is typically chosen to be somewhat less than the smallest dimension of the part to be formed. The blank is then expanded as determined by the size of the die cavity. Where portions of the tube blank are to be expanded to very large extents (e.g., greater than 30%), the wall thickness of the tube at such locations may become overly thin to the detriment of the part.

For certain applications wherein extended portions of the part can be provided with a generally constant cross-sectional shape (e.g., as would be produced by extrusion) there is no need to subject the entire part to a hydroforming process. In addition, it may be desirable to provide a hollow part that incorporates two or more uniformed cross section tubular members (e.g., formed by extrusion or roll forming), but of different cross-sectional shapes and/or dimensions from one another. To provide such a part is problematic, however, because of the need to connect tubes having dissimilar shapes and/or dimensions.

It is therefore an object of the present invention to overcome the difficulties noted above in a novel, cost-effective manner.

### SUMMARY OF THE INVENTION

The present invention is a method for forming a hollow part. To achieve the forgoing object, a first hollow member is provided which has a first open end and a second open end, the first end having a predetermined structural dimension and shape. A second hollow member is provided which also has a first open end and a second open end, the first end having a predetermined structural dimension and shape. The first end of the first hollow member differs from the first end of the second hollow member in dimension or shape or both. A third hollow member is formed, such that it has a first open end with a structural dimension and shape generally the same as the structural dimension and shape of the first end of the first hollow member and it has a second open end with a structural dimension and shape generally the same as the structural dimension and shape of the first end of the second hollow member. The forming of the third hollow member includes placing it into a die cavity of a hydroforming die assembly and expanding it into conformity with surfaces defining the die cavity so as to provide a portion thereof which is to constitute the first end with generally the same structural dimension and shape as the first end of the first hollow member upon expansion. The die cavity is further shaped such that another portion of the third hollow member, which constitutes the second end, will have substantially the same structural dimension and shape as the first end of the second hollow member. The first end of the third hollow member is welded to the first end of the first hollow member and the second end of the third hollow member is welded to the first end of the second hollow member.

In a second aspect of the present invention, a method for securing a fastener connecting sleeve into a pre-fabricated hollow member is provided. The hollow member has first and second opposing walls that have first and second holes respectively formed therein, and the first and second holes are aligned with first and second ends of the connecting sleeve respectively. The method comprises inserting the connecting sleeve into the interior of the hollow member through one end of the hollow member so that the connecting sleeve has its first and second opposing open ends disposed adjacent to the first and second walls of the hollow member. The first wall is then deformed to form a first flange that surrounds the first hole and projects into the first open end of the connecting sleeve. Similarly, the second wall is deformed to form a second flange that surrounds the second hole and projects into the second open end of the connecting sleeve. The first flange and second flange thus secure the first and second open ends of the connecting sleeve in alignment with the first and second hole to permit a fastener to pass therethrough.

### BRIEF DESCRIPTION OF THE DRAWINGS

FIG. 1 is an exploded, isometric view of a hollow part formed in accordance with the present invention;

FIG. 2 is a sectional view of a tubular blank in a hydroforming cavity in accordance with the invention;

FIG. 3 is a sectional view of the hollow member having been expanded in the hydroforming cavity in accordance with the invention;

FIG. 4 is sectional view of a generally conical tubular blank in a hydroforming cavity in accordance with another embodiment of the invention;

FIG. 5 is an isometric view of a reinforcing tube being inserted into a hollow member in accordance with another aspect of the invention; and

FIG. 6 is a sectional view of a hollow member and a reinforcing tube with flanging punches in accordance with the invention.

### DETAILED DESCRIPTION OF THE PREFERRED EMBODIMENTS

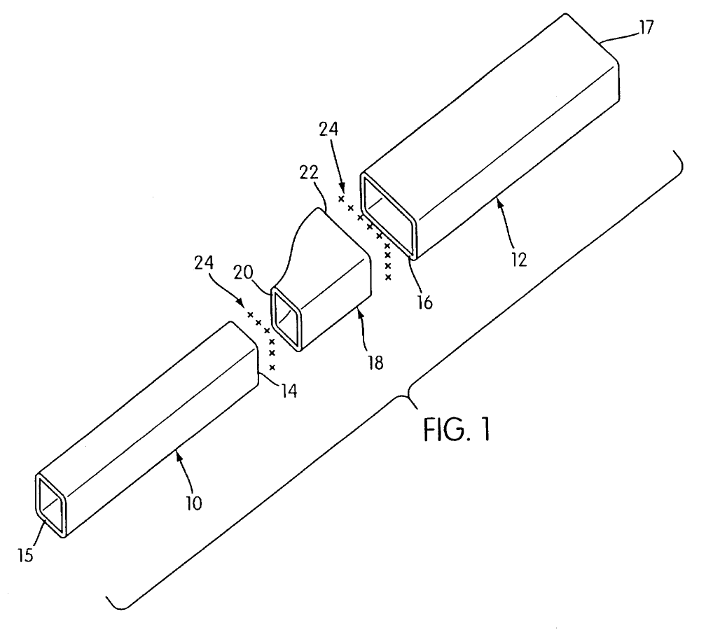

In a preferred embodiment of the present invention two hollow members 10, 12 are provided as shown in FIG. 1. The first of the two hollow members 10 has a first open end 14 with a predetermined structural dimension and shape and a second open end 15. The second of the two hollow members 12 also has a first open end 16 with a predetermined structural dimension and shape and a second open end 17. One or both of the dimension and shape of the first end 16 of the second hollow member 12 differ from that of the first end 14 of the first hollow member 10. The two hollow members 10, 12 may be of any metallic material and may be formed in any manner appropriate to the material and desired application, but most preferably extruded, and preferably made from aluminum. The members 10, 12 preferably have a multi-sided, non-cylindrical cross-section shape (e.g., triangular, quadrilateral, pentagonal).

In an alternate embodiment, each of the two hollow members 10, 12 may be hydroformed tubes.

To join the two hollow members 10, 12, a third hollow member 18 which acts as an adapter or transition member is formed which has a first open end 20 with generally the same structural dimension and shape as that of the first end 14 of the first hollow member 10, and which also has a second open end 22 with generally the same structural dimension and shape as that of the first end 16 of the second hollow member 12. Shown schematically in FIG. 1 are the weld lines 24 used to connect the third hollow member 18 to the first and second hollow members 10, 12.

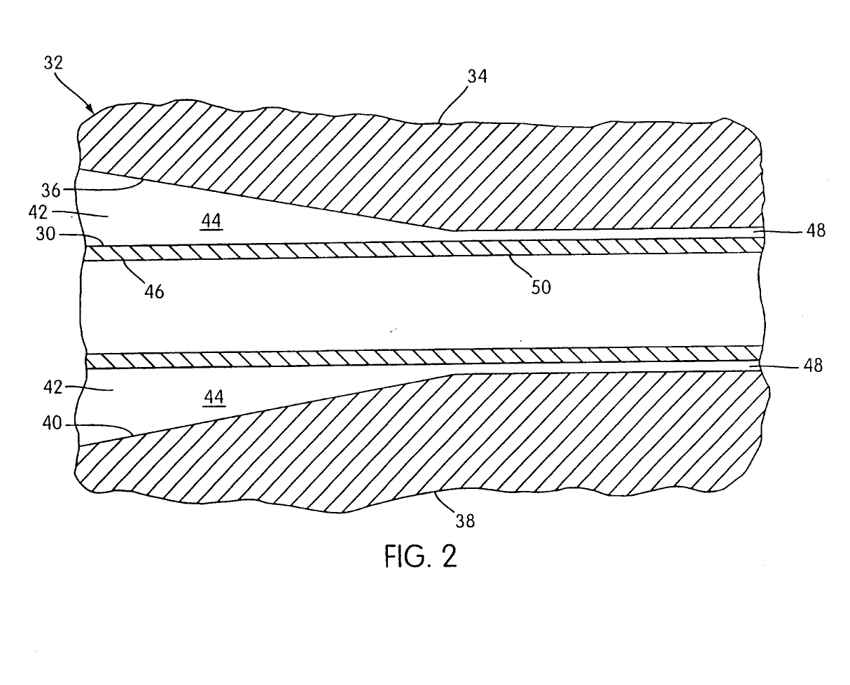

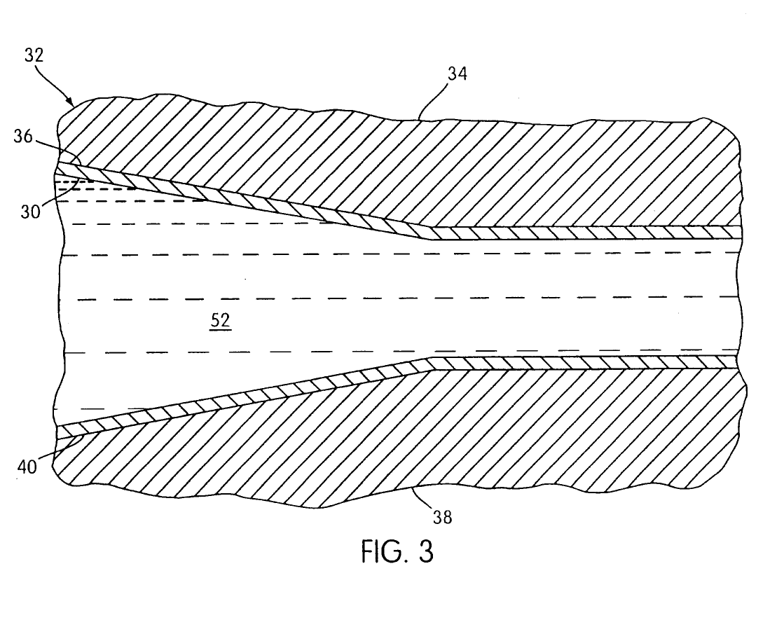

The adapter 18 is formed by hydroforming. More particularly, referring now to FIGS. 2 and 3, a tubular metal blank 30 is hydroformed into a component having differing transverse (cross-sectional) dimensions and/or shapes at the opposite ends 20, 22 thereof. As shown in FIG. 2, the blank 30 is placed into a hydroforming die 32 which has an upper portion 34 having an upper die surface 36 and a lower portion 38 having a lower die surface 40. When the upper and lower die portions 34, 38 are placed together, the upper die surface 36 and lower die surface 40 together define a die cavity 42. The die cavity 42 includes a first expanding portion 44 that is constructed and arranged to expand a first portion of the blank 46 to a first predetermined shape and dimension, and a second expanding portion 48 that is constructed and arranged to expand a second portion of the blank 50 to a second predetermined shape and dimension. At least one of the shape and dimension of the first portion is different from that of the second portion. After the blank 30 is placed between the upper and lower die portions 34, 38 and the upper and lower die portions 34 and 38 are placed together to define the die cavity 42. The ends of the blank are sealed by sealing rams as known in the art, as exemplified by the patents previously incorporated by reference. A high pressure hydroforming fluid 52 is introduced through one of the sealing members into the blank 30, causing it to expand into conformity with the surfaces 36, 40 of the die cavity as shown in FIG. 3.

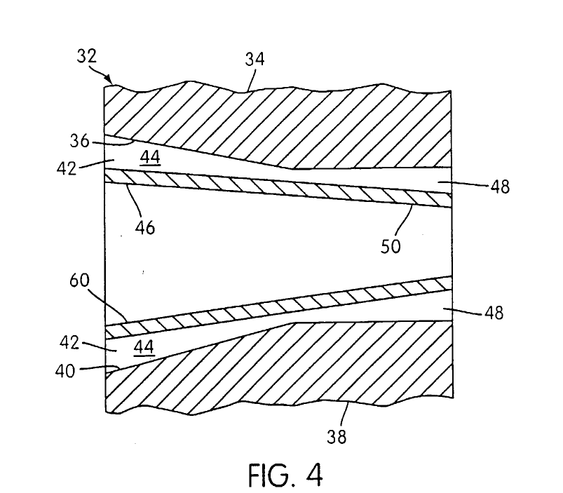

In the case where the desired structural dimensions of the ends of the finished third hollow member are of significantly differing dimensions (one end having a much greater cross-sectional perimeter than the other), a conical tubular blank 60 may be used instead of the conventional cylindrical tubular blank (see FIG. 4). Preferably, the conical tubular blank 60 is formed by rolling sheet metal into a generally conical tubular configuration. Such a conical blank 60 helps to overcome potential problems with excessive thinning of the tube where it must expand to a greater degree to conform to the die cavity surfaces 36, 40. That is, each end of the blank has a perimeter that corresponds more closely with the associated portions of the die into which it is to be expanded.

The shape and size of opposing portions of the die cavity are constructed to have the dimension required for the hydroformed part to have opposite ends 20, 22 thereof align geometrically and dimensionally with the ends 14 and 16 of the extruded tubes to be mated (welded) therewith. In this regard, it should be noted that the present invention appreciates that after the hydroformed adapter is removed from the hydroforming die, it may be necessary to cut off end portions of the hydroformed part that have been deformed in order to mate with the opposing sealing rams. This cutting-off step is known in the hydroforming art, but is not always required. In the case where cutting is required, the portions of the hydroforming die cavity which are constructed to provide the adapter member 18 with the desired shape and dimension at said opposite end portions are spaced inwardly from the end portions of the blank, and are located (aligned with) at the areas at which the part pulled out of the hydroforming die are to be cut. These cut ends 20, 22 are then welded to the ends 14, 16, respectively.

Where the finished hollow part is to be secured to another structural component, it may be desirable to punch a hole in the part and pass a fastener, such as a bolt, therethrough. Where tubes are formed from two longitudinal stamped halves which are subsequently welded longitudinally, it is relatively simple to include additional processing steps to include reinforcing members in the finished tube because access to the interior of the tube is available prior to welding. In the case where the tube is integrally formed as a one-piece member, such as by hydroforming or extrusion, however, the process becomes more difficult.

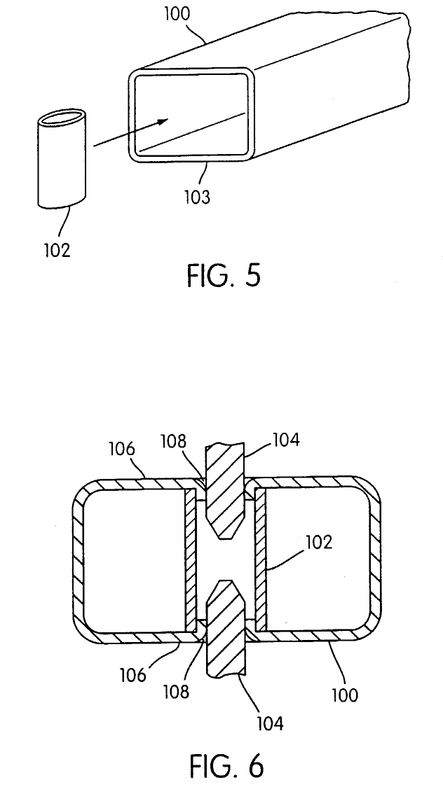

It is another object of the invention to provide an internal sleeve within an extruded and/or hydroformed tube to serve as reinforcement to the hollow part at such location. Specifically, to increase strength of the tube, a reinforcement sleeve 102 can be used to accept fasteners therethrough without risk of collapsing the tube. FIG. 6 shows a cross-section of a hollow member 100 with the reinforcing connecting sleeve 102 affixed therein. The connecting sleeve 102 is inserted into the hollow member 100 through an open end 103 thereof as shown in FIG. 5. To affix the sleeve 102, opposing flanging punches 104 are forced through opposite walls 106 of the hollow member, into open ends of the sleeve 102.

In a preferred embodiment, pre-punched holes are provided in the opposite walls 106, such holes having a smaller diameter than the diameter of the punches 104 and aligned with the open ends of sleeve 102. Thus, when the punches 104 are forced through such holes in the walls 106, the edges surrounding these holes are bent to form flanges 108 extending into the open ends of the sleeve 102. The pre-punched holes may, for example, be formed in a hydropiercing operation, in the instance where the tube 100 is a tube section formed by hydroforming.

In an alternate embodiment, no pre-punched hole is formed in the opposing tube walls 106, and the flanging punches 104 themselves form holes in opposite walls 106 of the hollow member. Material from the opposite walls 106 of the hollow member is deformed to form flanges 108. The flanges 108 are disposed around the circumference of the holes formed in the hollow member and extend into the opposite ends of the sleeve 102. In either embodiment, the flanges 108 fix the ends of the sleeve relative to the hollow member 100. Preferably, a computer numeric controlled hydraulic system is used to insert the sleeve 102 into the tube 100, to ensure that the punches 104 are aligned with the opened ends of the sleeve prior to the punching operation, and to force punches 104 inwardly. Alternately, a fixture can be used and the sleeve 102 inserted by hand. While the ends of the sleeve 102 can then be welded to the opposite tube walls 106 (e.g., by laser welding, projection welding, etc.), it is contemplated that the mechanical interlocking relationship of the flanges 108 within the sleeves 102 can be the sole means for securing the sleeve 102 to the tube 100.

It will be appreciated that the above descriptions are intended only to serve as examples, and that many other embodiments are possible within the the scope of the present invention.

What is claimed is:

1. A method for forming a hollow part comprising:
providing a first hollow member having a first open end and a second open end, said first end of said first hollow member having a predetermined structural dimension and shape;
providing a second hollow member having a first open end and a second open end, said first end of said second hollow member having a predetermined structural dimension and shape,
at least one of said predetermined structural dimension and shape of said first end of said first hollow member being different from the predetermined structural dimension and shape of said first end of said second hollow member;
forming a third hollow member having a first open end with generally the same structural dimension and shape as that of the first end of said first hollow member and having a second open end with generally the same structural dimension and shape as that of the first end of said second hollow member,
said forming including placing a third hollow member into a die cavity of a hydroforming die assembly and expanding said third hollow member into conformity with surfaces defining said die cavity so as to provide a portion thereof which is to constitute said first end thereof with generally the same structural dimension and shape as said first end of said first hollow member and to provide a portion thereof which is to constitute said second end thereof with generally the same structural dimension and shape as said first end of said second hollow member; and
welding said first end of said third hollow member to said first end of said first hollow member and welding said second end of said third hollow member to said first end of said second hollow member.

2. A method according to claim 1, wherein said first hollow member is provided by extruding a metal material so as to provide said first hollow member with a seamless and substantially constant cross section throughout its longitudinal extent.

3. A method according to claim 2, wherein said second hollow member is provided by extruding a metal material so as to provide said second hollow member with a seamless and substantially constant cross section throughout its longitudinal extent.

4. A method according to claim 1, wherein said first and second hollow members are provided by extruding aluminum.

5. A method according to claim 1, wherein said third hollow member placed in said die cavity of said hydroforming die assembly is formed by rolling sheet metal into a generally conical tubular configuration.

6. A method according to claim 1, wherein said first and second hollow members are provided by hydroforming.

7. A method of securing a fastener connecting sleeve into a pre-formed hollow member, said hollow member having opposing first and second walls, said first and second walls having first and second holes formed therein, said first and second holes being aligned with first and second ends of said connecting sleeve, respectively, said method comprising:
inserting the connecting sleeve into an interior of said hollow member through an open end of said hollow member so that said connecting sleeve has said opposing first and second open ends thereof disposed adjacent to the first and second walls of said hollow member, respectively;
deforming said first wall to form a first flange surrounding said first hole and projecting into said first open end of said connecting sleeve, and deforming aid second wall to form a second flange surrounding said second hole and projecting into said second open end of said connecting sleeve,
said first flange and said second flange securing said first and second open ends of said connecting sleeve in alignment with said first and second hole to permit a fastener to pass therethrough.

8. A method according to claim 7, wherein said holes are provided prior to deforming said first and second walls.

9. A method according to claim 7, wherein said deforming of said first and second walls forms said first and second holes as well as forming said first and second flanges.

10. A method according to claim 8, further comprising pre-forming said hollow member by extrusion.
